(19) United States
(12) Patent Application Publication
(10) Pub. No.: US 2007/0026866 A1
(43) Pub. Date: Feb. 1, 2007

(54) Mobile node, method and computer program product for handing off from one type of network to another type of network

(76) Inventors: Govindarajan Krishnamurthi, Arlington, MA (US); Tat Chan, San Diego, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/139,449

(22) Filed: May 27, 2005

(51) Int. Cl. H04Q 7/20

(52) U.S. Cl. 455/440

(57) ABSTRACT

A mobile node includes first and second communication interfaces for connecting to first and second types of networks, respectively. The mobile node also includes a processor capable of connecting to a first type of network via the first communication interface. The processor can monitor location information from the first type of network, the location information being representative of a geographic area within which the mobile node is currently located and available as a result of the connection to the first type of network. The processor can determine if the mobile node is currently located in an area associated with a second type of network based upon the monitoring of the location information. If so, the processor can turn on the second communication interface, and effectuate a handoff of the mobile node from the first type of network to the second type of network via the second communication interface.

### BACKGROUND OF THE INVENTION

The mobile Internet Protocol (MIP) enables a mobile terminal to move freely from one point of connection to another in various networks it visits along its route. In particular, the MIP protocol describes those actions that enable a mobile terminal to maintain connectivity during a handover from one access router to another access router. For example, a mobile terminal operating in an enhanced third-generation (3G) wireless communication network such as 1XEV-DO (TIA/EIA/IS-856) may desire to move to a wireless local area network (WLAN), and vice versa. In a more particular example, consider a terminal user engaged in a voice over IP (VoIP) call in a 1XEV-DO network. When the user enters an area, such as the user's office, providing WLAN connectivity, the user may desire to move the VoIP call from the 1XEV-DO network to the WLAN, such as to obtain better or more economical connectivity, speed, quality of service (QoS) and the like.

To effectuate handover of the mobile terminal from one type of network to another, consider a mobile terminal that is obtaining data service through cellular access (first type of network) when the mobile terminal enters an area where WLAN access (second type of network) is available, and accordingly discovers the WLAN access. In such an instance, the mobile terminal may switch to WLAN access for better services, lower costs, or any other reasons. However, it is power-consuming for the mobile terminal to constantly scan the WLAN spectrum for possible WLAN access. To reduce power consumption of the mobile terminal, the terminal user may manually instruct the mobile terminal to switch to WLAN access in order to offload to the WLAN. Such a technique for reducing power consumption, however, undesirably requires significant user intervention and can be rather cumbersome. Although one example is provided above, switching between other types of networks may also suffer from similar or other disadvantages.

### SUMMARY OF THE INVENTION

In light of the foregoing background, exemplary embodiments of the present invention provide an improved mobile node, method and computer program product for handing off from one type of network to another type of network. In accordance with exemplary embodiments of the present invention, a mobile node connected to a first type of network is capable of discovering an available second type of network in a manner that reduces power consumption and manual user intervention, as compared to some conventional techniques that require constant scanning or user intervention. In this regard, the mobile node of exemplary embodiments of the present invention is adapted to maintain a second communication interface for connecting to the second type of network in an off state, and only switch on the second communication interface when the likelihood of discovering an available second type of network is above a given threshold, where the likelihood is determined based upon information representative of an area within which the mobile node is currently located. In this regard, such location information can comprise information available to the mobile node as a result of its connection to the first type of network, without requiring additional power, bandwidth or other resource consumption of the mobile node, other than the resource consumption required to connect to the first type of network and maintain that connection.

According to one aspect of the present invention, a mobile node includes first and second communication interfaces for connecting to first and second types of networks, respectively. In addition, the mobile node includes a processor capable of connecting the mobile node to a first type of network (e.g., CDMA network) via the first communication interface, while maintaining the second communication interface in an off state. As the processor is connected to the first type of network, the processor is capable of monitoring location information from the first type of network. Further, if so desired, the processor can also be capable of monitoring information indicative of a routine of a user of the mobile node.

The location information is representative of a geographic area within which the mobile node is currently located. For example, the location information can comprise location information available to the mobile node independent of (without requiring) resource consumption of the mobile node other than that required to connect to the first type of network and maintain the connection to the first type of network. More particularly, for example, when the first type of network comprises a cellular network, the location information can comprise an identifier of a cell of the cellular network within which the mobile node is currently located, i.e., a cell ID. In addition to being representative of a geographic area, the location information is available to the mobile node as a result of the connection to the first type of network. Alternatively, for example, the location information can comprise information from outside the first and second types of networks, such as from a GPS satellite.

By monitoring the location information (and, if applicable, the information indicative of a routine of the user), the processor of one exemplary embodiment is capable of determining if the mobile node is currently located in an area associated with a second type of network (e.g., WLAN), or an instance of a second type of network, based upon the monitoring of the location information/routine information. For example, the mobile node can further include a memory capable of storing an access database including one or more areas associated with a second type of network, where the access database may further include at least one parameter sufficient to connect to the associated second type of network. The processor can then be capable of determining if the mobile node is currently located in an area associated with a second type of network based upon the access database and the area represented by the location information.

Thus, if the mobile node is currently located in an area associated with a second type of network, the processor may be capable of turning on the second communication interface. The processor can then effectuate a handoff of the mobile node from the first type of network to the second type of network (or instance of the second type of network) via the second communication interface, where effectuating the handoff includes the mobile node connecting to the second type of network. In addition, the processor can be capable of effectuating the handoff further at least partially based upon respective parameter(s) in an access database.

Effectuating the handoff to the second type of network can include turning off the first communication interface or operating the first communication interface in a dormant state. Continuing operation, then, the processor can be further capable of monitoring information from the second type of network. In this regard, the information from the second type of network can be representative of the mobile node moving away from the connected second type of network, and available to the mobile node as a result of the connection to the second type of network. More particularly, for example, the processor can be capable of monitoring an identifier associated with a base station to which the mobile node is connected, that base station being within the second type of network. In such instances, the processor can be capable of determining if the mobile node is moving away from the area by determining if the monitored identifier is within a set of one or more predetermined identifiers associated with base stations within the second type of network, but located proximate one or more boundaries of the second type of network.

Similar to before, by monitoring such information, then, the processor can be capable of determining if the mobile node is moving away from the area associated with the second type of network based upon the monitoring step. If the mobile node is moving away from the area associated with a second type of network, then, the processor can be capable of turning on the first communication interface. Thereafter, the processor can be capable of effectuating a handoff of the mobile node from the second type of network to the first type of network via the first communication interface, where effectuating the handoff includes the mobile node reconnecting to the first type of network.

According to other aspects of the present invention, a mobile node and method are provided for handing off the mobile node. Exemplary embodiments of the present invention therefore provide an improved mobile node, method and computer program product for handing off a mobile node. As indicated above, and explained below, in accordance with exemplary embodiments of the present invention, a mobile node connected to a first type of network via a first communication interface maintains a second communication interface in an off state. The mobile node can then switch on its second communication interface when location information available to the mobile node as a result of its connection to the first type of network indicates that the mobile node is currently located in the same geographic area as a second type of network. By switching on its second communication interface, the mobile node can effectuate handoff to the second type of network, including connecting to the second type of network via the second communication interface. As such, the mobile node, method and computer program product of exemplary embodiments of the present invention may solve at least some of the problems identified by prior techniques and may provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of mobile node and system that would benefit from exemplary embodiments of the present invention;

FIG. 2 is a schematic block diagram of an entity capable of operating as a mobile node, home agent, foreign agent and/or correspondent node, in accordance with exemplary embodiments of the present invention;

FIG. 3 is a schematic block diagram of a mobile node, in accordance with one embodiment of the present invention; and

FIGS. 4a and 4b are flowcharts illustrating various steps in a method of handing off a mobile node, in accordance with one embodiment of the present invention.

### DETAILED DESCRIPTION OF THE INVENTION

The present invention now will be described more fully hereinafter with reference to the accompanying drawings, in which exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

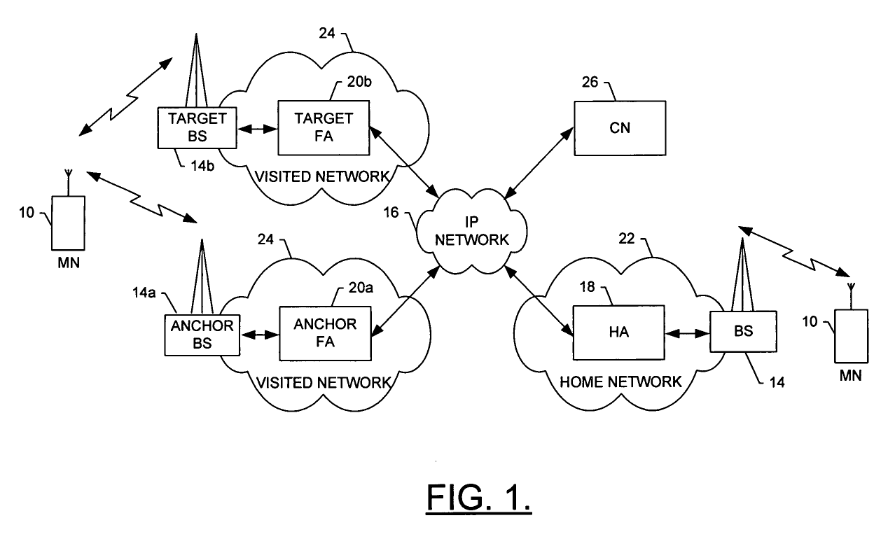

Referring to FIG. 1, an illustration of one type of system that would benefit from exemplary embodiments of the present invention is provided. The system, method and computer program product of exemplary embodiments of the present invention will be primarily described in conjunction with mobile communications applications. It should be understood, however, that the system, method and computer program product of exemplary embodiments of the present invention can be utilized in conjunction with a variety of other applications, both in the mobile communications industries and outside of the mobile communications industries. For example, the system, method and computer program product of exemplary embodiments of the present invention can be utilized in conjunction with wireline and/or wireless network (e.g., Internet) applications.

As shown, the system can include a mobile node (MN) 10 capable of transmitting signals to and for receiving signals from base sites or base stations (BS) 14 (one or more of which may be more particularly referred to as access points—AP's), two of which are shown in FIG. 1. As shown and described below, the base stations include an anchor BS 14a that provides access to one type of network (e.g., first type of network) and a target BS 14b that provides access to another type of network during handoff. One or more base stations are part of one or more cellular or mobile networks that each include elements required to operate the network, such as a mobile switching center (MSC) (not shown). As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also control the forwarding of messages for the terminal to and from a messaging center.

The MN 10 can also be coupled to a data network. For example, one or more base stations 14 can be coupled to one or more data networks, such as a local area network (LAN), a metropolitan area network (MAN), and/or a wide area network (WAN). In one typical embodiment, the BS is coupled to a gateway, which is coupled to the data network, such as an Internet Protocol (IP) network 16. The gateway can comprise any of a number of different entities capable of providing network connectivity between the MN and other nodes directly or indirectly coupled to the data network. As will be appreciated, the gateway can be described in any of a number of different manners, such as a home agent (HA) 18, foreign agent (FA) 20 (shown and described below as including an anchor FA 20a and a target FA 20b during handoff), packet data serving node (PDSN), access router (AR) or the like. In this regard, as defined in the MIP (MIP) protocol, a HA comprises a router within a home network 22 of the MN. The HA is capable of tunneling data for delivery to the MN when the MN is away from home, and can maintain current location information for the MN. A FA, on the other hand, comprises a router within a visited network 24 of the MN. The FA provides routing services to the MN while the MN is registered with the visited network. In operation, the FA detunnels data from the HA, and delivers the data to the MN. Then, for data sent from a MN registered with the visited network, the FA can serve as a default router. Although exemplary embodiments of the present invention may be described with reference to a MIP protocol, such as MIPv4 or MIPv6, it should be understood that exemplary embodiments of the present invention may operate in accordance with any of a number of other protocols.

The other nodes coupled to the MN 10 via the IP network 16 can comprise any of a number of different devices, systems or the like capable of communicating with the MN in accordance with exemplary embodiments of the present invention. The other nodes can comprise, for example, personal computers, server computers or the like. Additionally or alternatively, for example, one or more other nodes can comprise, other MNs, such as mobile telephones, portable digital assistants (PDAs), pagers, laptop computers, or the like. As described herein, a node capable of communicating with the MN via the IP network is referred to as a correspondent node (CN) 26, one of which is shown in FIG. 1.

Although not every element of every possible network is shown and described herein, it should be appreciated that the MN 10 can be coupled to one or more of any of a number of different networks. In this regard, mobile network(s) can be capable of supporting communication in accordance with any one or more of a number of second-generation (2G), 2.5G and/or third-generation (3G) mobile communication protocols or the like. Additionally or alternatively, mobile network(s) can be capable of supporting communication in accordance with any of a number of different wireless networking techniques, including WLAN techniques such as IEEE 802.11, WiMAX techniques such as IEEE 802.16 or the like. Further, for example, the mobile network(s) can be capable of supporting communication in accordance with any one or more of a number of different digital broadcast networks, such as Digital Video Broadcasting (DVB) networks including DVB-T (DVB-Terrestrial) and/or DVB-H (DVB-Handheld), Integrated Services Digital Broadcasting (ISDB) networks including ISDB-T (ISDB-Terrestrial), or the like.

More particularly, for example, the MN 10 can be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as cdma2000, Universal Mobile Telephone System (UMTS) network employing Wideband Code Division Multiple Access (WCDMA) radio access technology. Further, one or more of the network(s) can be capable of supporting enhanced 3G wireless communication protocols such as 1XEV-DO (TIA/EIA/IS-856) and 1XEV-DV.

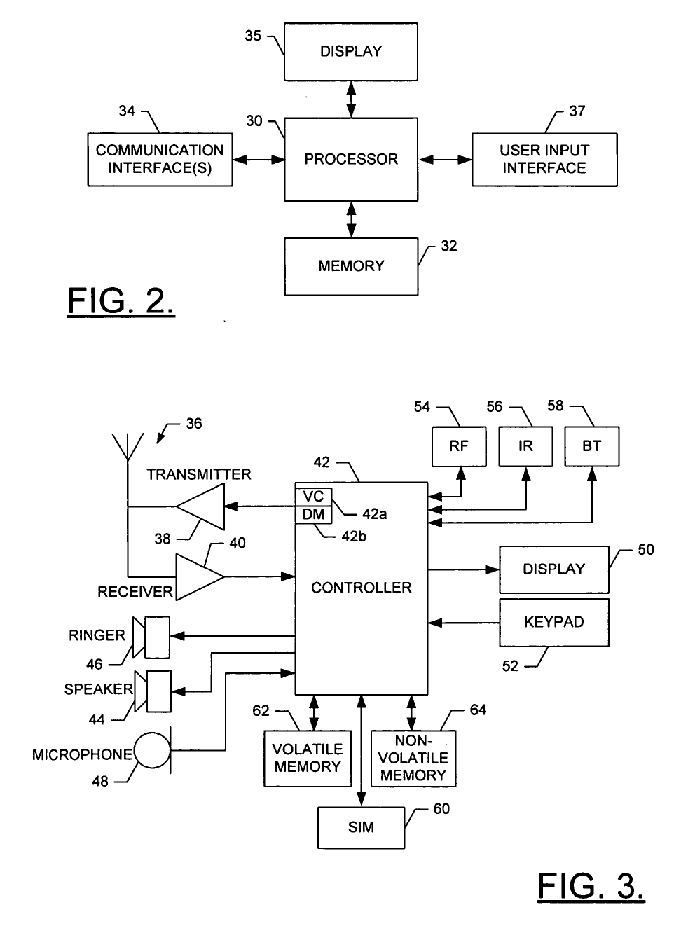

Referring now to FIG. 2, a block diagram of an entity capable of operating as a MN 10, HA 18, FA 20 and/or CN 26 is shown in accordance with one embodiment of the present invention. Although shown as separate entities, in some embodiments, one or more entities may support one or more of a MN, HA, FA and/or CN, logically separated but co-located within the entit(ies). For example, a single entity may support a logically separate, but co-located, HA and CN. Also, for example, a single entity may support a logically separate, but co-located FA and CN.

The entity capable of operating as a MN 10, HA 18, FA 20 and/or CN 26 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 30 connected to a memory 32. The memory can comprise volatile and/or non-volatile memory, and typically stores content, data or the like. For example, the memory typically stores content transmitted from, and/or received by, the entity. Also for example, the memory typically stores client applications, instructions or the like for the processor to perform steps associated with operation of the entity in accordance with embodiments of the present invention. As explained below, for example, the memory can store client application(s).

As described herein, the client application(s) may each comprise software operated by the respective entities. It should be understood, however, that any one or more of the client applications described herein can alternatively comprise firmware or hardware, without departing from the spirit and scope of the present invention. Generally, then, the MN 10, HA 18, FA 20 and/or CN 26 can include one or more logic elements for performing various functions of one or more client application(s). As will be appreciated, the logic elements can be embodied in any of a number of different manners. In this regard, the logic elements performing the functions of one or more client applications can be embodied in an integrated circuit assembly including one or more integrated circuits integral or otherwise in communication with a respective network entity (i.e., MN, HA, FA, CN, etc.) or more particularly, for example, a processor 30 of the respective network entity. The design of integrated circuits is by and large a highly automated process. In this regard, complex and powerful software tools are available for converting a logic level design into a semiconductor circuit design ready to be etched and formed on a semiconductor substrate. These software tools, such as those provided by Avant! Corporation of Fremont, Calif. and Cadence Design, of San Jose, Calif., automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 32, the processor 30 can also be connected to at least one interface or other means for displaying, transmitting and/or receiving data, content or the like. In this regard, the interface(s) can include at least one communication interface 34 or other means for transmitting and/or receiving data, content or the like. As explained below, for example, the communication interface(s) can include a first communication interface for connecting to a first network, and a second communication interface for connecting to a second network. In addition to the communication interface(s), the interface(s) can also include at least one user interface that can include a display 35 and/or a user input interface 37. The user input interface, in turn, can comprise any of a number of devices allowing the entity to receive data from a user, such as a keypad, a touch display, a joystick or other input device.

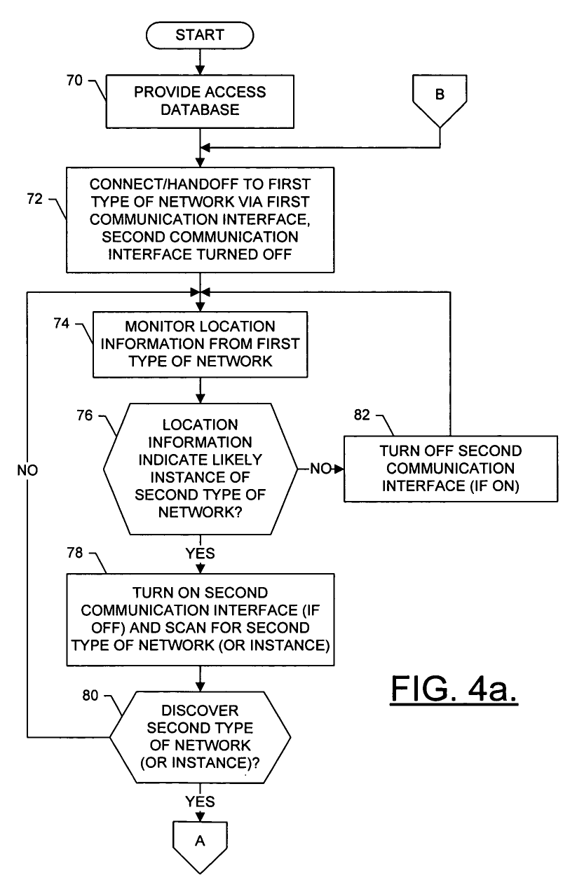

Reference is now made to FIG. 3, which illustrates one type of MN 10 that would benefit from exemplary embodiments of the present invention. It should be understood, however, that the MN illustrated and hereinafter described is merely illustrative of one type of MN that would benefit from the present invention and, therefore, should not be taken to limit the scope of the present invention. While several exemplary embodiments of the MN are illustrated and will be hereinafter described for purposes of example, other types of MNs, such as portable digital assistants (PDAs), pagers, laptop computers and other types of electronic systems, can readily employ exemplary embodiments of the present invention.

The MN 10 includes various means for performing one or more functions in accordance with exemplary embodiments of the present invention, including those more particularly shown and described herein. It should be understood, however, that the MN may include alternative means for performing one or more like functions, without departing from the spirit and scope of the present invention. More particularly, for example, as shown in FIG. 3, in addition to an antenna 36, the MN 10 can include a transmitter 38, receiver 40, and controller 42 or other processor that provides signals to and receives signals from the transmitter and receiver, respectively. These signals include signaling information in accordance with the air interface standard of the applicable cellular system, and also user speech and/or user generated data. In this regard, the MN can be capable of operating with one or more air interface standards, communication protocols, modulation types, and access types. More particularly, the MN can be capable of operating in accordance with any of a number of second generation (2G), 2.5G and/or third-generation (3G) communication protocols or the like. For example, the MN may be capable of operating in accordance with 2G wireless communication protocols IS-136 (TDMA), GSM and IS-95 (CDMA), 2.5G wireless communication protocols such as GPRS and/or Enhanced Data GSM Environment (EDGE), and/or 3G wireless communication protocols such as cdma2000, Universal Mobile Telephone System (UMTS) network employing Wideband Code Division Multiple Access (WCDMA) radio access technology. Also, for example, the MN can also be capable of operating in accordance with enhanced 3G wireless communication protocols such as 1XEV-DO (TIA/EIA/IS-856) and 1XEV-DV. Further, for example, the MN can be capable of operating in accordance with any of a number of different wireless networking techniques, including WLAN techniques such as IEEE 802.11, WiMAX techniques such as IEEE 802.16 or the like.

It is understood that the controller 42 includes the circuitry required for implementing the audio and logic functions of the MN 10. For example, the controller may be comprised of a digital signal processor device, a microprocessor device, and various analog-to-digital converters, digital-to-analog converters, and other support circuits. The control and signal processing functions of the MN are allocated between these devices according to their respective capabilities. The controller can additionally include an internal voice coder (VC) 42a, and may include an internal data modem (DM) 42b. Further, the controller may include the functionally to operate one or more software programs, which may be stored in memory (described below). For example, the controller may be capable of operating a connectivity program, such as a conventional Web browser. The connectivity program may then allow the MN to transmit and receive Web content, such as according to HTTP and/or the Wireless Application Protocol (WAP), for example.

The MN 10 also comprises a user interface including a conventional earphone or speaker 44, a ringer 46, a microphone 48, a display 50, and a user input interface, all of which are coupled to the controller 42. The user input interface, which allows the MN to receive data, can comprise any of a number of devices allowing the MN to receive data, such as a keypad 52, a touch display (not shown) or other input device. In embodiments including a keypad, the keypad includes the conventional numeric (0-9) and related keys (#, *), and other keys used for operating the MN. Although not shown, the MN can include a battery, such as a vibrating battery pack, for powering the various circuits that are required to operate the MN, as well as optionally providing mechanical vibration as a detectable output.

The MN 10 can also include one or more means for sharing and/or obtaining data. For example, the MN can include a short-range radio frequency (RF) transceiver 54 so that data can be shared with and/or obtained from electronic devices in accordance with RF techniques. In this regard, the RF transceiver may function as a WLAN and/or WAN interface capable of sharing data with other radio frequency transceivers in accordance with WLAN and/or WAN techniques. The MN can additionally, or alternatively, include other short-range transceivers, such as, for example an infrared (IR) transceiver 56, and/or a Bluetooth (BT) transceiver 58 operating using Bluetooth brand wireless technology developed by the Bluetooth Special Interest Group. The MN can therefore additionally or alternatively be capable of transmitting data to and/or receiving data from electronic devices in accordance with such techniques.

The MN 10 can further include memory, such as a subscriber identity module (SIM) 60, a removable user identity module (R-UIM) or the like, which typically stores information elements related to a mobile subscriber. In addition to the SIM, the MN can include other removable and/or fixed memory. In this regard, the MN can include volatile memory 62, such as volatile Random Access Memory (RAM) including a cache area for the temporary storage of data. The MN can also include other non-volatile memory 64, which can be embedded and/or may be removable. The non-volatile memory can additionally or alternatively comprise an EEPROM, flash memory or the like. The memories can store any of a number of software applications, instructions, pieces of information, and data, used by the MN to implement the functions of the MN. For example, the memories can store an identifier, such as an international mobile equipment identification (IMEI) code, international mobile subscriber identification (IMSI) code, mobile station integrated services digital network (MSISDN) code (mobile telephone number), Internet Protocol (IP) address, Session Initiation Protocol (SIP) address or the like, capable of uniquely identifying the MN.

As explained in the background section, MIP enables a MN 10 to move freely from one point of connection to another in various networks it visits along its route. In particular, the MIP protocol describes those actions that enable a MN to maintain connectivity during a handover from one access router to another access router. Briefly, MIP enables the mobile node to be identified by its home address, regardless of its current point of attachment to the IP network 16. When the MN is in a visiting network 24 away from the home network 22, it is also associated with a care-of-address, which provides information about the MN's current location. Typically, during a handoff between FAs 20 the care-of-address changes but the home address remains the same.

As also indicated in the background section, a MN 10 that is connected to a first type of network via a first communication interface can be enabled to handoff from the first type of network to a second type of network. In such instances, the MN is configured to turn on a second communication interface and constantly scan for an available second type of network to which the MN is capable of being handed off, and upon discovering a second type of network, effectuating a handoff from the first type of network to the second type of network. However, it is power-consuming for the MN to constantly scan for an available second type of network. And whereas the user manually instructing the MN to handoff to the second type of network may reduce power consumption of the MN, such a technique undesirably requires significant user intervention and can be rather cumbersome.

Therefore, in accordance with exemplary embodiments of the present invention, a MN 10 connected to a first type of network is capable of discovering an available second type of network in a manner that may reduce power consumption and manual user intervention, as compared to conventional techniques that require constant scanning or user intervention. To reduce power consumption required to constantly scan for an available second type of network, the MN 10 may only switch on a second communication interface to scan for an available second type of network when the likelihood of discovering an available second type of network is above a given threshold. In this regard, one piece of information the MN can use to determine this likelihood is its current location.

For a MN 10 connected to a first type of network, a number of different pieces of information are available (or otherwise determinable from information available) to the MN as a result of its connection. Typically, this type of information includes information that may be representative of a geographic area within which the MN is currently located (“location information”). When the MN is connected to a cellular network, for example, location information available to the MN as a result of its connection to the cellular network typically includes an identifier of a cell of the cellular network within which the MN is located (i.e., a cell ID), although it should be understood that the location information available to the MN may additionally or alternatively include other information that may be representative of a location or geographic area within which the MN is located. More particularly, for example, in GSMIGPRS networks, location information includes the operator name (mobile country and network codes—MCC and MNC), location area code (LAC) and cell ID. In this regard, the operator name identifies the network operator, the LAC represents a coarse location area, and the cell ID represents the particular cell within which the MN is currently located (typical cells ranging from 100 m to 3 km or more). Similarly, cell ID information is also available to a MN connected to a CDMA-based network, a WCDMA-based network or the like. Irrespective of the exact location information provided to the MN, however, such location information is typically readily available to the MN without requiring additional power, bandwidth, or other resource consumption of the MN, other than the resource consumption required to connect to the first type of network and maintain that connection.

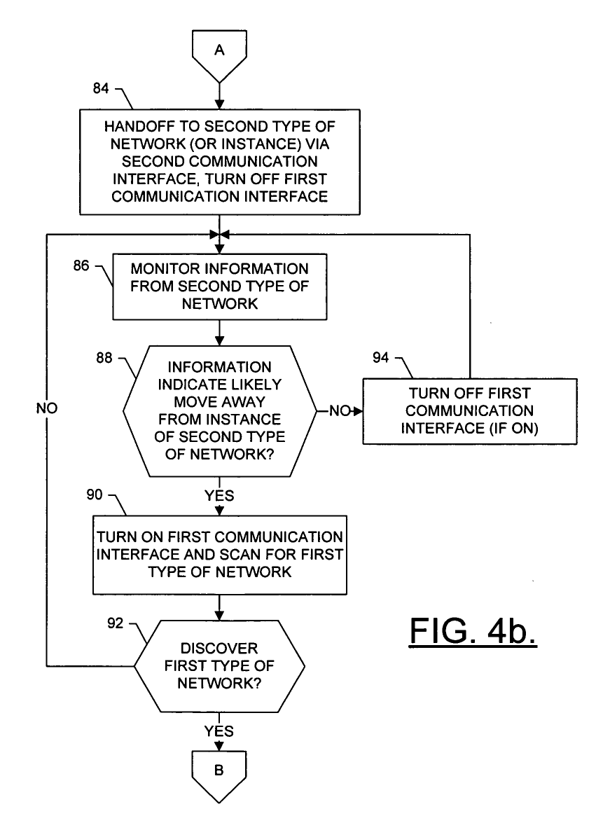

Reference is now made to FIGS. 4a and 4b, which illustrates a control flow diagram of a method of handing off a MN 10 from a current, anchor FA 20a to a new, target FA 20b, such as during a communication session between the MN and a CN 26. As explained herein, the MN is handed off from an anchor FA to a target FA. It should be understood, however, that the MN can be equally handed off from an anchor HA 18 to a target FA, or alternatively from an anchor FA to a target HA, without departing from the spirit and scope of the present invention. Also, as explained below, the method of FIG. 6 is particularly applicable to handing off a MN from a first, primary type of network to a second, alternative type of network. More particularly, the method of FIG. 6 will be explained in conjunction with handing off a MN from an anchor PDSN (i.e., anchor FA) in a CDMA (e.g., cdma2000, 1XEV-DO, etc.) network to a target AR (i.e., target FA) in a WLAN. It should be understood, however, that the method of FIG. 6 can be equally applicable to handing off a MN from any of a number of other types of networks to any of a number of other types of networks, including from a second, alternative type of network (e.g., WLAN) to a first, primary type of network (e.g., CDMA network, WCDMA network, etc.), without departing from the spirit and scope of the present invention. It should further be understood that whereas the method of FIG. 6 is shown and described with respect to one alternative type of network (i.e., second type of network), the method can be equally applicable to more than one alternative type of network (e.g., third type of network, fourth type of network, etc.). In such instances, the method of FIG. 6 may function for handing off a MN from one alternative type of network (e.g., second type of network) to another alternative type of network (e.g., third type of network), and vice versa.

As shown in FIGS. 4a and 4b, one exemplary method of handing off a MN 10 from an anchor FA 20a in a first type of network to a target FA 20b in a second type of network includes providing an access database (e.g., in memory 32, 64, etc.) that includes location information representative of a plurality of different geographic areas, as shown in block 70. Each represented area, in turn, is associated with a second type of network to which the MN may connect via an appropriate communication interface. And if more than one instance of the second type of network may be available within an area, the represented area may be more particularly associated with one or more instances of the second type of network. For purposes of illustration, then, the second type of network (e.g., WLAN) is described below as including more than one instance, although the second type of network need not include multiple instances.

If not otherwise discoverable by the MN, for each instance of the second type of network, the access database includes one or more parameters sufficient for the MN to connect to the respective instance of the second type of network. In the case of an instance of a WLAN (i.e., second type of network), for example, the access database can include an access profile including information such as the WLAN SSID (service set identifier), channel information, protection keys and the like.

The access database can be provided, as well as updated or otherwise modified, in any of a number of different manners. For example, the access database may be provisioned by a network operator, or otherwise made available for download by the MN 10. The operator may then distribute updates to the access database, or make such updates available for download, as appropriate (e.g., periodically, when updates become available, etc.). As will be appreciated, such provisioning or making available for download may be particularly applicable in the case of operator-owned second types of networks (e.g., operator-owned WLAN's—OWLAN's). In addition to or in lieu of provisioning or downloading the access database to the MN, for example, a MN user may create, update or otherwise modify an access database, such as by manually inputting entries into the access database via a user input interface. Further, for example, the MN may be configured to create, update or otherwise modify an access database through a learning process. In accordance with one such process, then, each time the MN user manually turns on the second communication interface and successfully connects to an instance of the second type of network, the MN can add an appropriate entry to an access database for the area within which the MN is currently located.

Irrespective of exactly how the access database is provided, the method of FIGS. 4a and 4balso includes the MN 10 connecting to the first type of network via the first communication interface, as shown in block 72. More particularly, the MN of this exemplary embodiment connects to a BS 14 via the first communication interface to thereby connect to a FA 20 in the first network via the BS, where the BS then functions as the anchor BS 14a and the FA functions as the anchor FA 20a. For example, the MN may connect to a BS in a CDMA (e.g., cdma2000, 1XEV-DO, etc.) network or a WCDMA network via a radio communication interface of the MN to thereby connect to a respective PDSN in the CDMA network. With the MN connected to the first type of network, the second communication interface of the MN is maintained in an off state or is otherwise turned off, as also shown.

As the MN 10 is connected to the first type of network, the MN may monitor location information from the first type of network, as shown in block 74. In this regard, as indicated above, as a result of the connection to the first network, location information is typically available (or otherwise determinable) that may be representative of a geographic area within which the MN is currently located. Such location information may include, for example, a MCC, MNC, LAC and/or cell ID. Irrespective of the exact location information provided to the MN, however, such location information is typically readily available to the MN without requiring additional power, bandwidth other resource consumption of the MN, other than the resource consumption required to connect to the first type of network and maintain that connection.

As the MN 10 monitors location information representative of the area within which the MN is currently located, the MN may determine if the location information indicates a likely instance of the second type of network in the same geographic area, as shown in block 76. More particularly, the MN can compare the location information to that in the access database to determine if the MN is currently located in an area associated with an instance of the second type of network. If the MN is not currently located in an area associated with an instance of the second type of network, the MN may continue to monitor location information from the first network (shown via block 82, described below). If the MN is currently located in an area associated with an instance of the second type of network, however, the MN may turn on the second communication interface and scan for the associated instance of the second type of network, as shown in block 78. The MN may scan for the associated instance of the second type of network in a constant manner, or alternatively in a regular or irregular periodic manner if so desired. Further, to maintain constant network access, the MN typically (but not always) maintains its connection to the first type of network via the first communication interface as the second communication interface scans for the associated instance of the second type of network.

As the MN 10 scans for the associated instance of the second type of network, the MN may attempt to discover the respective instance of the second type of network, or more particularly the BS 14 of the respective instance of the second type of network, as shown in block 80. In this regard, until the MN discovers the respective instance of the second type of network, the MN may continue to monitor location information from the first network (see block 74). Thus, if the location information indicates that the MN has moved out of the area associated with the instance of the second type of network, the MN may turn the second communication interface off and then continue to monitor location information from the first network, as shown in block 82 (and block 74). Alternatively, if the location information indicates that the MN has moved into an area associated with another instance of the second type of network, the MN may scan for the other instance of the second type of network (see block 78). Otherwise, if the location information indicates that the MN remains in the same area, the MN may continue to scan for an associated instance of the second type of network, as before.

Referring now to FIG. 4b, if the MN 10 discovers the associated instance of the second type of network, the MN may be handed off from the first type of network to the respective instance of the second type of network, as shown in block 84. The MN can be handed off in any of a number of different known manners, such as that provided by the MIP protocol. In one exemplary embodiment, however, as the MN is connected to the anchor BS 14a in the first type of network via the first communication interface, the MN establishes a connection to a target BS 14b in the respective instance of the second type of network via the second communication interface. As the MN connects to the target BS, the MN likewise connects to a target FA 20b in the instance of the second type of network via the target BS. Thus, with the MN having been handed off from the first type of network to the instance of the second type of network, future packets to and from the MN can be routed from and to the target FA and then to the MN, as opposed to the anchor FA 20a and then the MN. Further, before, after or as the MN is handed off to the associated instance of the second type of network, the MN can (but need not) disconnect from the first type of network and turn off the first communication interface.

Alternatively, the MN can (but again need not) put the first communication interface in a dormant state, where some signaling messages may be sent, received and processed, but requires much less power and resource consumption of the MN.

As the MN 10 is connected to the instance of the second type of network, the MN can monitor information available (or otherwise determinable from information available) from the second type of network, as shown in block 86. This information can include location information, as before. Additionally or alternatively, however, this information can include information representative of the MN moving away from the connected instance of the second type of network. For example, the information can include a signal strength or signal-to-noise ratio (SNR) of the connection to the instance of the second type of network.

As the MN 10 monitors information available (or otherwise determinable from information available) from the connected instance of the second type of network, the MN determines if the monitored information indicates a likely move away from the connected instance of the second type of network, as shown in block 88. For example, the MN can compare the signal strength or SNR of the connection with the instance of the second type of network with a predefined threshold. If the signal strength or SNR is equal to or greater than the predefined threshold, the MN continues to monitor information from the second network (shown via block 94, described below). If the signal strength or SNR is less the predefined threshold, however, the MN turns on the first communication interface and scans for the first type of network, as shown in block 90.

In addition to or in lieu of monitoring the signal strength or SNR, the MN 10 can monitor information to determine if the information indicates a likely move away from the connected instance of the second type of network in any of a number of other manners. For example, presume that the connected instance of the second type of network comprises a WLAN within an office building, where the WLAN includes one or more particular BS's 14 (access point(s)) located near one or more boundaries of the WLAN (e.g., near outside door(s) of the building), and the particular BS(s) are associated SSID(s) in a set of predetermined SSID(s). In such an instance, the MN can compare the SSID of the BS to which the MN is connected to the set of predetermined SSID(s). If the SSID of the BS to which the MN is connected is not within the set of predetermined SSID(s), the MN may continue to monitor information from the second network (see block 94, described below). If the respective SSID is within the set of predetermined SSID(s) (indicating that the MN is near a boundary of the WLAN), however, the MN may turn on the first communication interface and scan for the first type of network (see block 90).

As will be appreciated, information such as signal strength, SNR or SSID can be separately monitored to determine if the MN 10 is likely moving away from the connected instance of the second type of network. In various other instances, however, the MN may monitor multiple pieces of information, such as by monitoring the signal strength or SNR as well as the SSID of the BS 14 to which it is connected. In such instances, the MN may be capable of making an even more precise determination of whether the MN is likely moving away from the connected instance of the second type of network, as compared to instances where the MN singularly monitors the different pieces of information.

Irrespective of how the MN 10 determines that the monitored information indicates a likely move away from the connected instance of the second type of network, similar to before, the MN may scan for the first type of network in a constant manner, or alternatively in a regular or irregular periodic manner if so desired. Further, to maintain constant network access, the MN may (but need not) maintain its connection to the instance of the second type of network via the second communication interface as the first communication interface scans for the first type of network.

As the MN 10 scans for the first type of network, the MN may attempt to discover the first type of network, or more particularly a BS 14 of the first type of network, as shown in block 92. In this regard, until the MN discovers the first type of network, the MN may continue to monitor information from the second network (see block 86). Thus, if the information indicates that the MN is no longer likely moving away from the connected instance of the second type of network, such as when the signal strength or SNR increases to equal or greater than the predefined threshold, or the SSID of the BS 14 to which the MN is connected is no longer within the set of predetermined SSID(s) of BS(s) near one or more boundaries of the connected instance of the second type of network, the MN can turn the first communication interface off (or put it in a dormant state) and then continue to monitor information from the second network, as shown in block 94 (and block 86). Alternatively, if the information indicates that the MN remains likely to move away from the connected instance of the second type of network, the MN can continue to scan for the first type of network, as before. Then, if the MN 10 discovers the first type of network, the MN may be handed off from the connected instance of the second type of network back to the first type of network, as shown again in block 72 of FIG. 4a.

The method can then continue as before, with the MN 10 monitoring location information representative of the area within which the MN is currently located, and the MN determining if the location information indicates a likely instance of the second type of network in the same geographic area. As will be appreciated, from one occasion to the next of handing off from the first, primary type of network, the other type of network may differ, as may the instance of the other type of network. For example, on one occasion the MN may be handed off from a CDMA or WCDMA network (i.e., first type of network) to a first WLAN (i.e., first instance of a second type of network). Then, on the next occasion, the MN may be handed off from the CDMA or WCDMA network to the first WLAN or alternatively to another, second WLAN (i.e., second instance of the second type of network).

To further illustrate exemplary embodiments of the present invention, consider a MN 10 having a CDMA radio interface (i.e., first communication interface) for connecting to CDMA networks such as cdma2000, 1XEV-DO or the like (i.e., first type of network). In addition, the MN has a WLAN interface (i.e., second communication interface) for connecting to WLAN's (i.e., second type of network). During typical operation, the CDMA radio interface is maintained in an on state. Also during typical operation, the cell ID (i.e., location information) of the cell of the CDMA network within which the MN is currently located is provided to the MN by the CDMA network, and is available to the MN whenever CDMA coverage is available. During operation, the MN 10 may connect to the CDMA network via the CDMA radio interface to thereby gain access to the Internet (i.e., IP network 16). Whenever access to a WLAN is available to the MN, however, the MN user may desire that the MN be handed off from the CDMA network to the available WLAN to obtain, for example, better or more economical connectivity, speed, quality of service (QoS) and the like.

In addition, consider that the MN 10 of this exemplary embodiment maintains an access database including n records for n cell ID's, such as in the following manner:

| | | | Alternative | |
|---|---|---|---|---|
| Record | Label | Cell ID | Networks | Access Profile |
| 1 | Office | 4041 | Enterprise WLAN | Enterprise WLAN |
| | | | | profile |
| 2 | Road | 4045 | NIL | N/A |
| 3 | Road | 4046 | NIL | N/A |
| 4 | Mall | 4148 | Coffee shop WLAN | Coffee shop WLAN |
| | | | | profile |
| | | | Book store WLAN | Book store WLAN |
| | | | | profile |
| . . . | . . . | . . . | . . . | . . . |
| n | Home | 3280 | Home WLAN | Home WLAN profile |

In the preceding example access database, each record has a label and associates or otherwise binds a cell ID (i.e., location information) to one or more instances of a WLAN to which the MN may connect via the WLAN interface. Further, each instance of a WLAN has an access profile that includes one or more parameters (e.g., WLAN SSID, channel information, protection keys, etc.) sufficient for the MN to connect to the respective instance. In other embodiments, the database may be constructed in other manners if desired.

To reduce power consumption required to constantly scan for an available WLAN, the MN 10 of this exemplary embodiment is configured such that as MN accesses the Internet via the CDMA network, the WLAN interface is maintained in an off state by default. As the MN is connected to the CDMA network, the MN monitors cell ID information provided by the CDMA network. Presume that the MN user enters the office. In such a case, the cell ID reported from the CDMA network is 4041. The MN therefore checks the database and determines that the access database includes a record for cell ID 4041, and that cell ID 4041 is associated with an enterprise WLAN (i.e., instance of the second type of network). In response, the MN turns on its WLAN interface and scans for the enterprise WLAN. If and when the MN discovers the enterprise WLAN, the MN is handed off to the enterprise WLAN such that the MN can access the Internet via the enterprise WLAN. In addition, the MN turns off the CDMA radio interface, or put the interface in a dormant state.

Now, presume the MN user leaves the office. As the MN 10 moves away from the enterprise WLAN, the signal strength decreases to below a predefined threshold. Additionally, within the enterprise WLAN, the MN may be handed off to a BS 14 (access point) having a SSID within a predetermined set of SSID(s). Accordingly, the MN turns its CDMA radio interface back on, scans for a CDMA network and, upon discovering such a network, is handed off thereto. The MN then turns off its WLAN interface. Upon being handed off to the CDMA network, the CDMA reports the cell ID 4045. Similar to before, the MN checks the database and determines that the access database includes a record for cell ID 4045. Unlike the previous occasion, however, cell ID 4045 is not associated with a WLAN (the same effect being that the database does not include a record for cell ID 4045). Thus, the MN continues to monitor the cell ID available from the CDMA network while connected to the CDMA network via the CDMA radio interface. Thus, when the user arrives home, the cell ID reported by the CDMA network becomes 3280, which is associated in the access database with a home WLAN (i.e., instance of the second type of network). Similar to the occasion of handing off to the enterprise WLAN, in response to identifying the cell ID associated with the home WLAN, the MN turns on its WLAN interface and scans for the home WLAN. If and when the MN discovers the home WLAN, the MN is handed off to the home WLAN, and turns off the CDMA radio interface, or puts the CDMA radio interface in a dormant state.

As explained above, the access database of this exemplary embodiment includes location information representative of a geographic area within which the MN may be located, where each area is associated with one or more instances of a second type of network. It should therefore be understood that an area may be associated with more than one instance of a second type of network. As shown in above, for example, cell ID 4148 may be associated with two WLAN networks, i.e., coffee shop WLAN and book store WLAN. In such instances, the MN may be configured to function in any of a number of different manners. For example, the MN may be configured to scan for both instances and handoff to the first discovered instance. Alternatively, the MN may be configured to select one of the instances for which to scan, that instance being selected based upon a number of different factors. Such factors may include, for example, cost to access the different instances, and/or level of security and/or bandwidth offered by the different instances.

In addition, it should be understood that an area may be associated with one or more instances of more than one alternative type of network. For example, a cell ID may be associated with a WLAN network and a WiMAX network. Similar to multiple instances of the same alternative type of network, the MN may be configured to function in any of a number of different manners. For example, the MN may be configured to scan for both alternative types of networks and handoff to the first discovered alternative type of network. Alternatively, the MN may be configured to select one of the alternative types of networks for which to scan, that alternative type being selected based upon a number of different factors. Similar to before, such factors may include, for example, cost to access the different instances, and/or level of security and/or bandwidth offered by the different instances.

Further, it should be understood that whereas the MN 10 may turn its interface(s) to different types of networks on and off based upon information from another type of network to which the MN is connected, the MN may turn its interface(s) on and off based upon more sophisticated algorithms. Also, for example, the MN may be configured to create, update or otherwise modify an access database to associate alternative types of networks (and/or instances) not only with location information obtained from the first and second types of networks, but also with information obtained outside of the first and second types of networks. Such information may or may not have direct location implications to the MN.

More particularly, for example, in various instances the MN 10 may be capable of obtaining its location outside of its connection to the first and second types of networks, such as by being GPS (global positioning system) enabled to communicate with GPS satellites to obtain raw location information that more precisely represents the current location of the MN. This more precise location of the MN can be used by the MN for any of a number of different purposes, either by the client application operating in accordance with exemplary embodiments of the present invention, or another client application of the MN. In such instances, when the MN turns on its second communication interface, the MN may obtain raw location information, such as from a GPS satellite or another client application configured to obtain such information, and associate the more precise location of the MN (e.g., the raw location information or a representation of the same) with the alternative types of networks (and/or instances) in the access database. Thereafter, at one or more instances when the MN is connected to the first type of network, such as in regular or irregular periodic manner, the MN can be configured to again obtain raw location information representative of the current location of the MN. The MN can then compare the current, more precise location of the MN (e.g., the raw location information or a representation of the same) with the more precise location(s) of the MN with alternative types of networks (and/or instances) in the access database. If the MN detects a match, the MN can turn on another of its communication interfaces (e.g., second communication interface) and begin scanning for the respective type of network (e.g., second type of network). For further information on such a technique, see U.S. Provisional Patent Application No. 60/672,471 entitled: System and Method for Dynamically Changing a Request for Location Information, filed Apr. 18, 2005, the contents of which are hereby incorporated by reference in its entirety.

Also, for example, as the MN user may have one or more routine behaviours (e.g., driving from home to work, from work to lunch, etc.), the MN 10 may be configured to create, update or otherwise modify an access database to associate alternative types of networks (and/or instances) not only with location information, but also with other information such as times of the day, previous location information (e.g., previous cell ID(s)) or the like. With such an access database, for example, if the cell ID (i.e., location information) changes from that associated with the user's home (e.g., cell ID 3280) to that associated with the user's office (e.g., cell ID 4041), and the time of the day is indicative of the user's daily routine of driving from home to work, the MN 10 may determine that the cell ID change is likely part of the user's daily routine of driving from home to work. Additionally or alternatively, for example, if the cell ID (i.e., location information) changes from that associated with the user's home (e.g., cell ID 3280) to that associated with one or more cells along a route from the user's home to the user's office, and then changes to that of the user's office (e.g., cell ID 4041), the MN may determine that the cell ID change is likely part of the user's daily drive to work. Thus, when the cell ID becomes that of the office, the MN may turn on its WLAN interface start periodically scanning for an appropriate WLAN (e.g., enterprise WLAN).

In addition, the MN 10 may be configured to measure typically how much time passes between the cell ID (i.e., location information) changing to that of the office and the MN discovering an associated alternative network (or instance), and associate that time with the respective cell ID in the access database. For example, the MN may be configured to measure typically how much time passes between the cell ID changing to that of the office and the MN discovering the enterprise WLAN. Initially, the MN has no information regarding the elapsed time. However, presume that on the first day of use, the user manually connects to the enterprise WLAN 30 minutes after the user enters the cell covering his office. Then, on the second day, the user manually connects to the enterprise WLAN five minutes after the user enters the respective cell. The MN can track such measurements over time to compute a time period, such as an average or weighted average time period. Accordingly, instead of starting to scan for the enterprise WLAN immediately after identifying the respective cell ID, the MN may be configured to wait the average time period or some other period of time based upon the average time period before starting to scan for the enterprise WLAN. As will be appreciated, since the geographical area covered by a cell ID may be large, configuring the MN to turn its interface(s) on and off based upon more sophisticated algorithms such as those described above further optimizes the power consumption by delaying activation of the second communication interface until the likelihood of realizing connectivity to the second type of network is higher than that provided by the cell ID alone.

According to one exemplary aspect of the present invention, the functions performed by one or more of the entities of the system, such as the MN 10, anchor FA 20a and target FA 20b, may be performed by various means, such as hardware and/or firmware, including those described above, alone and/or under control of a computer program product. The computer program product for performing one or more functions of exemplary embodiments of the present invention includes a computer-readable storage medium, such as the non-volatile storage medium, and software including computer-readable program code portions, such as a series of computer instructions, embodied in the computer-readable storage medium.

In this regard, FIGS. 4a and 4b are flowcharts of systems, methods and program products according to exemplary embodiments of the present invention. It will be understood that each block or step of the flowcharts, and combinations of blocks in the flowcharts, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

Many modifications and other exemplary embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A mobile node comprising:
a first communication interface for connecting to a first type of network;
a second communication interface for connecting to a second type of network; and
a processor capable of connecting the mobile node to a first type of network via the first communication interface, wherein the processor is capable of maintaining the second communication interface in an off state,
wherein the processor is capable of monitoring location information representative of an area within which the mobile node is currently located,
wherein the processor is capable of determining if the mobile node is currently located in an area associated with a second type of network based upon the monitoring of the location information,
wherein, if the mobile node is currently located in an area associated with a second type of network, the processor is capable of turning on the second communication interface, and effectuating a handoff of the mobile node from the first type of network to the second type of network via the second communication interface, and wherein effectuating a handoff includes the mobile node connecting to the second type of network.

2. A mobile node according to claim 1 further comprising:
a memory capable of storing an access database including at least one area associated with a second type of network,
wherein the processor is capable of determining if the mobile node is currently located in an area associated with a second type of network based upon the access database and the area represented by the location information.

3. A mobile node according to claim 1, wherein the processor is capable of effectuating the handoff including one of turning off the first communication interface or operating the first communication interface in a dormant state,
wherein the processor is further capable of monitoring information from the second type of network, the information being representative of the mobile node moving away from the connected second type of network, and being available to the mobile node as a result of the connection to the second type of network,
wherein the processor is capable of determining if the mobile node is moving away from the area associated with the second type of network based upon the monitoring step,
wherein, if the mobile node is moving away from the area associated with a second type of network, the processor is capable of turning on the first communication interface, and effectuating a handoff of the mobile node from the second type of network to the first type of network via the first communication interface, and wherein effectuating a handoff includes the mobile node reconnecting to the first type of network.

4. A mobile node according to claim 3, wherein the second type of network includes at least one base station for connecting to the second type of network, wherein the processor is capable of monitoring information from the second type of network comprising an identifier associated with the base station of the second type of network to which the mobile node is connected, and
wherein the processor is capable of determining if the mobile node is moving away from the area by determining if the monitored identifier is within a set of at least one predetermined identifier associated with at least one base station of the second type of network located proximate at least one boundary of the second type of network.

5. A mobile node according to claim 1, wherein the processor is capable of determining if the mobile node is currently located in an area associated with an instance of a second type of network, and
wherein the processor is capable of effectuating a handoff to the instance of the second type of network.

6. A mobile node according to claim 1, wherein the location information monitored by the processor comprises location information from the first type of network, the location information being available to the mobile node as a result of the connection to the first type of network.

7. A mobile node according to claim 6, wherein the first type of network comprises a cellular network, wherein the processor is capable of monitoring location information comprising an identifier of a cell of the cellular network within which the mobile node is currently located, and
wherein the processor is capable of determining if the identifier is associated with a second type of network.

8. A mobile node according to claim 1, wherein the location information monitored by the processor comprises location information from outside the first and second types of networks.

9. A mobile node according to claim 1, wherein the processor is further capable of monitoring information indicative of a routine of a user of the mobile node, and wherein the processor is capable of determining if the mobile node is currently located in an area associated with a second type of network based upon the monitoring of the location information and the information indicative of the routine.

10. A method of handing off a mobile node, the method comprising:
connecting the mobile node to a first type of network via a first communication interface of the mobile node, wherein the mobile node also includes a second communication interface, the second communication interface being in an off state;
monitoring location information representative of an area within which the mobile node is currently located;
determining if the mobile node is currently located in an area associated with a second type of network based upon the monitoring step; and if the mobile node is currently located in an area associated with a second type of network,
turning on the second communication interface; and effectuating a handoff of the mobile node from the first type of network to the second type of network via the second communication interface, wherein effectuating a handoff includes the mobile node connecting to the second type of network.

11. A method according to claim 10 further comprising:
maintaining an access database including at least one area associated with a second type of network,
wherein the determining step comprises determining if the mobile node is currently located in an area associated with a second type of network based upon the access database and the area represented by the location information.

12. A method according to claim 10, wherein the effectuating step includes one of turning off the first communication interface or operating the first communication interface in a dormant state, and wherein the method further comprises:
monitoring information from the second type of network, the information being representative of the mobile node moving away from the connected second type of network, and being available to the mobile node as a result of the connection to the second type of network;
determining if the mobile node is moving away from the area associated with the second type of network based upon the monitoring step; and if the mobile node is moving away from the area associated with a second type of network,
turning on the first communication interface; and
effectuating a handoff of the mobile node from the second type of network to the first type of network via the first communication interface, wherein effectuating a handoff includes the mobile node reconnecting to the first type of network.

13. A method according to claim 12, wherein the second type of network includes at least one base station for connecting to the second type of network, wherein monitoring information from the second type of network comprises monitoring an identifier associated with the base station of the second type of network to which the mobile node is connected, and
wherein determining if the mobile node is moving away from the area comprises determining if the monitored identifier is within a set of at least one predetermined identifier associated with at least one base station of the second type of network located proximate at least one boundary of the second type of network.

14. A method according to claim 10, wherein the determining step comprises determining if the mobile node is currently located in an area associated with an instance of a second type of network, and
wherein the effectuating step comprises effectuating a handoff to the instance of the second type of network.

15. A method according to claim 10, wherein the monitoring step comprises monitoring location information from the first type of network, the location information being available to the mobile node as a result of the connection to the first type of network.

16. A method according to claim 15, wherein the first type of network comprises a cellular network, wherein the monitoring step comprises monitoring an identifier of a cell of the cellular network within which the mobile node is currently located, and
wherein the determining step comprises determining if the identifier is associated with a second type of network.

17. A method according to claim 10, wherein the monitoring step comprises monitoring location information from outside the first and second types of networks.

18. A method according to claim 10, wherein the monitoring step further comprises monitoring information indicative of a routine of a user of the mobile node.

19. A computer program product for handing off a mobile node, the computer program product comprising at least one computer-readable storage medium having computer-readable program code portions stored therein, the computer-readable program code portions comprising:
a first executable portion for connecting the mobile node to a first type of network via a first communication interface of the mobile node, wherein the mobile node also includes a second communication interface, the second communication interface being in an off state;
a second executable portion for monitoring location information representative of an area within which the mobile node is currently located;
a third executable portion for determining if the mobile node is currently located in an area associated with a second type of network based upon the monitoring step;
a fourth executable portion for turning on the second communication interface; and
a fifth executable portion for effectuating a handoff of the mobile node from the first type of network to the second type of network via the second communication interface, wherein effectuating a handoff includes the mobile node connecting to the second type of network,
wherein the fourth and fifth executable portions are adapted to turn on the second communication interface and effectuate a handoff if the mobile node is currently located in an area associated with a second type of network.

20. A computer program product according to claim 19 further comprising:
a sixth executable portion for maintaining an access database including at least one area associated with a second type of network,
wherein the third executable portion is adapted to determine if the mobile node is currently located in an area associated with a second type of network based upon the access database and the area represented by the location information.

21. A computer program product according to claim 19, wherein the fifth executable portion is adapted to effectuate a handoff including one of turning off the first communication interface or operating the first communication interface in a dormant state, and wherein the computer program product further comprises:
a sixth executable portion for monitoring information from the second type of network, the information being representative of the mobile node moving away from the connected second type of network, and being available to the mobile node as a result of the connection to the second type of network;
a seventh executable portion for determining if the mobile node is moving away from the area associated with the second type of network based upon the monitoring step;
an eighth executable portion for turning on the first communication interface; and
a ninth executable portion for effectuating a handoff of the mobile node from the second type of network to the first type of network via the first communication interface, wherein effectuating a handoff includes the mobile node reconnecting to the first type of network, and
wherein the eighth and ninth executable portions are adapted to turn on the first communication interface and effectuate a handoff if the mobile node is moving away from the area associated with a second type of network.

22. A computer program product according to claim 21, wherein the second type of network includes at least one base station for connecting to the second type of network, wherein the sixth executable portion is adapted to monitor an identifier associated with the base station of the second type of network to which the mobile node is connected, and
wherein the seventh executable portion is adapted to determine if the monitored identifier is within a set of at least one predetermined identifier associated with at least one base station of the second type of network located proximate at least one boundary of the second type of network.

23. A computer program product according to claim 19, wherein the seventh executable portion is adapted to determine if the mobile node is currently located in an area associated with an instance of a second type of network, and
wherein the ninth executable portion is adapted to effectuate a handoff to the instance of the second type of network.

24. A computer program product according to claim 19, wherein the second executable portion is adapted to monitor location information from the first type of network, the location information being available to the mobile node as a result of the connection to the first type of network.

25. A computer program product according to claim 24, wherein the first type of network comprises a cellular network, wherein the second executable portion is adapted to monitor an identifier of a cell of the cellular network within which the mobile node is currently located, and
wherein the third executable portion is adapted to determine if the identifier is associated with a second type of network.

26. A computer program product according to claim 19, wherein the second executable portion is adapted to monitor location information from outside the first and second types of networks.

27. A computer program product according to claim 19, wherein the second executable portion is adapted to further monitor information indicative of a routine of a user of the mobile node.

28. A mobile node comprising:
a first means for connecting the mobile node to a first type of network via a first communication interface of the mobile node, wherein the mobile node also includes a second communication interface, the second communication interface being in an off state;
a second means for monitoring location information representative of an area within which the mobile node is currently located;
a third means for determining if the mobile node is currently located in an area associated with a second type of network based upon the monitoring step;
a fourth means for turning on the second communication interface; and
a fifth means for effectuating a handoff of the mobile node from the first type of network to the second type of network via the second communication interface, wherein effectuating a handoff includes the mobile node connecting to the second type of network,
wherein the fourth and fifth means are adapted to turn on the second communication interface and effectuate a handoff if the mobile node is currently located in an area associated with a second type of network.

29. A mobile node according to claim 28 further comprising:
a sixth means for maintaining an access database including at least one area associated with a second type of network,
wherein the third means is adapted to determine if the mobile node is currently located in an area associated with a second type of network based upon the access database and the area represented by the location information.

30. A mobile node according to claim 28, wherein the fifth means is adapted to effectuate a handoff including one of turning off the first communication interface or operating the first communication interface in a dormant state, and wherein the mobile node further comprises:
a sixth means for monitoring information from the second type of network, the information being representative of the mobile node moving away from the connected second type of network, and being available to the mobile node as a result of the connection to the second type of network;
a seventh means for determining if the mobile node is moving away from the area associated with the second type of network based upon the monitoring step;
an eighth means for turning on the first communication interface; and
a ninth means for effectuating a handoff of the mobile node from the second type of network to the first type of network via the first communication interface, wherein effectuating a handoff includes the mobile node reconnecting to the first type of network, and
wherein the eighth and ninth means are adapted to turn on the first communication interface and effectuate a handoff if the mobile node is moving away from the area associated with a second type of network.

31. A mobile node according to claim 30, wherein the second type of network includes at least one base station for connecting to the second type of network, wherein the sixth means is adapted to monitor an identifier associated with the base station of the second type of network to which the mobile node is connected, and
wherein the seventh means is adapted to determine if the monitored identifier is within a set of at least one predetermined identifier associated with at least one base station of the second type of network located proximate at least one boundary of the second type of network.

32. A mobile node according to claim 28, wherein the seventh means is adapted to determine if the mobile node is currently located in an area associated with an instance of a second type of network, and
wherein the ninth means is adapted to effectuate a handoff to the instance of the second type of network.

33. A mobile node according to claim 28, wherein the second means is adapted to monitor location information from the first type of network, the location information being available to the mobile node as a result of the connection to the first type of network.

34. A mobile node according to claim 33, wherein the first type of network comprises a cellular network, wherein the second means is adapted to monitor an identifier of a cell of the cellular network within which the mobile node is currently located, and
wherein the third means is adapted to determine if the identifier is associated with a second type of network.

35. A mobile node according to claim 28, wherein the second means is adapted to monitor location information from outside the first and second types of networks.

36. A mobile node according to claim 28, wherein the second means is adapted to further monitor information indicative of a routine of a user of the mobile node.
